(19) United States
(12) Patent Application Publication
(10) Pub. No.: US 2013/0275114 A1
(43) Pub. Date: Oct. 17, 2013

(54) COORDINATION SIMULATION SYSTEM AND COORDINATION SIMULATION METHOD

(71) Applicant: Hitachi, Ltd., Tokyo (JP)

(72) Inventor: KENTA MORISHIMA, Yokohama-shi (JP)

(21) Appl. No.: 13/648,609

(22) Filed: Oct. 10, 2012

(30) Foreign Application Priority Data
Oct. 12, 2011 (JP) 2011-224500

(51) Int. Cl. G06F 9/455

(52) U.S. Cl. CPC G06F 9/455
USPC 703/26

(57) ABSTRACT

A coordination simulation system, in which a system simulator including a plant model and a CPU simulator that controls by a microcomputer model are configured via a feedback loop, comprises a synchronization adapter that synchronizes the system simulator and the CPU simulator, wherein the synchronization adapter is provided with a function that provides alignment information per control cycle to the microcomputer model in accordance with a synchronizing signal generated in the plant model.

### CLAIM OF PRIORITY

The present application claims priority from Japanese Patent Application 2011-224500 filed on Oct. 12, 2011, the content of which is hereby incorporated by reference into this application.

### FIELD OF THE INVENTION

The present invention relates to a coordination simulation system and a coordination simulation method in which plural simulators are operated in a linked state, particularly it relates to coordination simulation suitable for the development of a built-in system mounted in a product such as electronic equipment for an automobile, electronic equipment for home, and electronic equipment for medical treatment.

### BACKGROUND OF THE INVENTION

When control algorithm designed in a system simulator such as a matrix laboratory (MATLAB: registered trademark) is applied to an actual product, the control algorithm is often realized by a microcontroller (a microcomputer). Therefore, to verify the control algorithm in a binary code of the microcomputer, coordination simulation that operates two simulators of a system simulator and a CPU simulator in a linked state is effective.

An example of such coordination simulation is disclosed in Japanese Patent Application Laid-Open Publication No. 2010-128987 and Japanese Patent Application Laid-Open Publication No. 2007-233675. In Japanese Patent Application Laid-Open Publication No. 2010-128987, it is described that simulation precision is secured by operating each simulator in a linked state using the transition of a timer generated by software itself for a trigger without deteriorating simulation efficiency. In addition, in Japanese Patent Application Laid-Open Publication No. 2007-233675, there is disclosed a simulation system 18 configured by electronic equipment which is provided with an event arithmetic unit 77 and in which a CPU simulator 15 and an external model executing unit 16 execute operation only when an event trigger from a simulation engine 70 is input.

### SUMMARY OF THE INVENTION

In coordination simulation, verification algorithm is designed to verify an operating state when control algorithm is mounted in a product and in the case of verification, a coordination simulation system shown in FIG. 9A, including a model (a control model) 22 of the control algorithm and a plant model 12 and having a feedback loop is used. The data of the plant model 12 is digitized in a system simulator and a value is updated every sampling cycle (control cycle).

As shown in FIG. 9B, when the control model 22 shown in FIG. 9A is connected with the control model replaced by a CPU simulator (a microcomputer model) 32, the two simulators are synchronized in relation to simulation time, however, it is not guaranteed that the start timing of processing in a sampling cycle executed in a program of CPU coincides with the start timing of the system simulator.

According to the research of the inventors, a situation that control algorithm designed in a system simulator and satisfactorily operated in an actual product is not satisfactorily operated in coordination simulation may occur.

First, referring to FIG. 10, timer interruption action in a conventional type coordination simulation system will be described. In the CPU simulator (the microcomputer model) 32, a timer is set (S110), the timer is activated (S111), in the case of time interruption (S112=Yes), data processing is executed (S113), the timer interruption is cleared (S114), and the next activation of the timer is awaited. In such timer interruption action, the start timing of the processing in the sampling cycle may be delayed from the start timing of the system simulator.

FIG. 11 shows a pipeline of processing in the conventional type coordination simulation system. In FIG. 11, (1) shows input to the CPU simulator, (2) shows processing in the CPU simulator, and (3) shows output from the CPU simulator. A reference numeral 210 denotes the transition of data input to the CPU, 211 denotes notable data input to the CPU, 220 denotes the transition of the data processed by the CPU, 221 denotes notable data processed by the CPU, 230 denotes the transition of data output from the CPU, and 231 denotes notable data output from the CPU. Further, reference numerals 241 to 245 denote system simulator data update timing. As shown in the transition of the data processed by the CPU 220 shown in FIG. 11, the processing of the CPU is not completed in one cycle of the system simulator, in other words, by the start time of the next cycle 243 like the data 221 and the timing of the output (230) of the CPU may be delayed by one cycle like the data 231 depending upon the processing time of the CPU and its start timing.

That is, in the coordination simulation, a phenomenon occurs that a lag between the update timing of the plant model and the start timing of processing by the microcomputer model is not stable and the processing of the microcomputer model is not completed by the next update timing of the plant model. The phenomenon of the lag does not reappear in actual equipment and appears only in the simulation. That is, a result of simulation by the microcomputer model of the control algorithm may be different from the operation of the control algorithm in the actual equipment. In other words, the reliability of the result of verification by the coordination simulation is not high.

Japanese Patent Application Laid-Open Publication No. 2010-128987 is provided with a mechanism that detects timer interruption to CPU and makes a system simulator step. In order to activate the mechanism, however, one necessary timer is required to be selected out of plural (for example, ten) timers of a CPU simulator, a control line for interrupt control is required to be extended, and the used timer may be changed depending upon a program. Further, a mechanism that makes the system simulator itself step by a trigger from a CPU simulator is required to be built, and the increase of man-hours and the occurrence of bugs by alteration are feared.

In Japanese Patent Application Laid-Open Publication No. 2007-233675, an event trigger is input to both the CPU simulator 15 and the external model executing unit 16 by the output of the event arithmetic unit 77 and operation is executed. However, a new event arithmetic unit 77 for applying timing synchronized with both a plant model and a microcomputer model is required to be provided and Japanese Patent Application Laid-Open Publication No. 2007-233675 also has a problem that the operation of the external model executing unit 16 is influenced by the operation of the event arithmetic unit 77 and the precision of simulation is deteriorated.

An object of the present invention is to provide a coordination simulation system and a coordination simulation method where a lag between the update timing of a plant model and the start timing of processing by a microcomputer model in the coordination simulation system is eliminated and precise coordination simulation is realized.

For one example of the representative of the present invention, the coordination simulation system is based upon a coordination simulation system in which a system simulator of a plant model and a CPU simulator that controls by a microcomputer model are configured via a feedback loop and includes a synchronization adapter that synchronizes the system simulator and the CPU simulator in which the synchronization adapter includes a function which provides alignment information per control cycle to the CPU simulator in accordance with a synchronizing signal in the plant model.

According to one aspect of the present invention, since input-output to/from the CPU simulator are made in synchronization with the control cycle of the system simulator with simple configuration that the synchronization adapter is only added between both simulators, precise coordination simulation can be ordinarily realized.

### BRIEF DESCRIPTION OF THE DRAWINGS

FIG. 1 is a block diagram showing a coordination simulation system according to one embodiment of the present invention;

FIG. 2A shows a hardware configuration of a plant model in the coordination simulation system shown in FIG. 1 and explains its operation;

FIG. 2B shows a software configuration of the plant model in the coordination simulation system shown in FIG. 1 and explains its operation;

FIG. 2C shows relation among a communication interval Ti between simulators, a sampling/control cycle Ts and CPU processing time Tp in the present invention;

FIG. 3 shows a pipeline of the processing of a control model for the system simulator as a comparative example;

FIG. 4A is a chart for explaining the operation of the microcomputer model in the coordination simulation system shown in FIG. 1;

FIG. 4B is a flowchart for explaining interruption action by a synchronization adapter in the coordination simulation system shown in FIG. 1;

FIG. 5 shows a pipeline of processing when the synchronization adapter is applied in the present invention;

FIG. 6 shows an example in which coordination simulation is applied to a coordination simulation system according to the control algorithm of a hard disk drive (HDD) and analysis by MATLAB and the calibration of the coordination simulation are made;

FIG. 7 shows a result acquired by evaluating the effect of the adoption of the synchronization adapter by the method shown in FIG. 6 when the coordination simulation according to the present invention is applied to the coordination simulation system of the HDD;

FIG. 8 shows a result acquired by evaluating a case that no synchronization adapter is adopted in the coordination simulation system of the HDD by the method shown in FIG. 6 as a comparative example;

FIG. 9A is a block diagram showing feedback control in coordination simulation;

FIG. 9B is a block diagram showing feedback control when a CPU simulator is replaced in the coordination simulation;

FIG. 10 is a flowchart for explaining timer interruption action in a conventional type coordination simulation system; and

FIG. 11 shows the pipeline of processing when the delay of the processing occurs while no synchronization adapter is applied.

### MODE FOR CARRYING OUT THE INVENTION

The present invention includes plural means for solving the problem, for example, which includes a system simulator for a plant model and a CPU simulator for control, in which data to which a time stamp is affixed is exchanged between the simulators at a fixed interval and which generates an interrupt to CPU at the data update timing of the system simulator.

Referring to the drawings, a coordination simulation system that precisely makes coordination simulation according to the present invention will be described below.

### First Embodiment

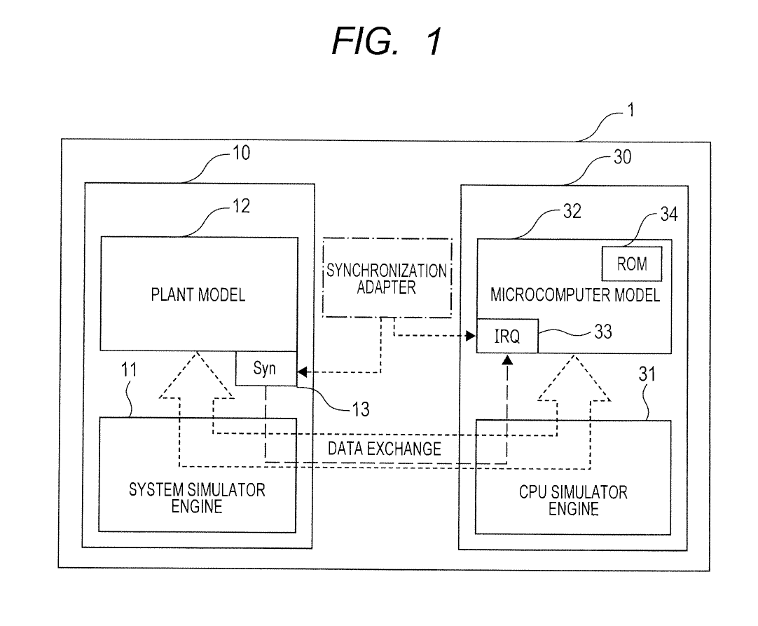

FIG. 1 shows an example of the configuration of a coordination simulation system 1 according to this embodiment. The coordination simulation system 1 includes a system simulator 10 and a CPU simulator 30. The two simulators include each timer that independently generates a clock system inside. I/O data between the two simulators are exchanged as data to which a time stamp is affixed at every set simulation time. The system simulator 10 includes a system simulator engine 11 and a plant model 12 executed in the system simulator engine. In the plant model 12, a synchronizing signal that provides a system simulator data update timing is generated based upon the clock system. The system simulator is also provided with a synchronizing pulse oscillator (Syn) 13 that generates a pulse signal using the synchronizing signal as it is. An interrupt signal from the synchronizing pulse oscillator 13 is generated at the update timing of the system simulator. The CPU simulator 30 includes a CPU simulator engine 31, a microcomputer model 32 configured in the CPU simulator engine and a program built in ROM 34 in the microcomputer model 32.

The present invention includes the synchronizing pulse oscillator (Syn) 13 and an interrupt request terminal (IRQ) 33 and in the present invention, configuration that synchronizes the system simulator 10 and the CPU simulator 30 is defined as a synchronization adapter. Data to which a time stamp is affixed are exchanged between the both simulators at a fixed interval and an interrupt to CPU of the CPU simulator 30 is generated at the data update timing of the system simulator 10.

Alignment information per control cycle S, for example, the information of a leading edge of a phase is supplied from the system simulator 10 to the CPU simulator 30 by the synchronization adapter. As described above, in the present invention, the oscillator Syn 13 is provided to the plant model 12 so as to output a signal in accordance with the data update timing of the plant model 12 in synchronization with the control cycle S. For an example of installation, the pulse oscillator having the same cycle as the control cycle S is installed and a leading edge the delay of which is zero and the amplitude of which is 1 has only to be set as a starting point. When the model has plural control cycles, plural pulse oscillators (Syn) 13 of the number of the control cycles have only to be installed in the plant model 12.

For example, in the case of control over an engine of an automobile, a plant model of the system simulator 10 is relatively abstract control algorithm designed by MATLAB based upon system design and mounting design (control design), the system simulator engine 11 is controlled by the operation information of an accelerator, a brake and others based upon the control design and control output from the CPU simulator 30, and various information such as engine speed generated in the system simulator 10 is input to the CPU simulator 30 as control input. In the CPU simulator 30, the program (the control algorithm) built in the ROM 34 is a program for engine control to be mounted in a microcomputer of the automobile and the CPU simulator engine 31 is a computer provided with the same function as a computer for control to be mounted in the automobile. As described above, the system simulator 10 and the CPU simulator 30 are different in a degree of abstraction. Control algorithm is verified at an early stage of product development by executing such coordination simulation, a problem is extracted, and feedback to product development including a program can be made. For example, in the analysis of algorithm based upon control design, though control performance can be evaluated, the accurate analysis in mounting in the actual automobile of response characteristics and others of an engine under control by the microcomputer and the details of a microcomputer mounting cost and others are unknown. In the meantime, in analysis by a mounted microcomputer, though detailed analysis based upon a binary code can be made, control algorithm cannot be represented by a system model at an early stage. To meet these requests and to suitably promote the development of software and the development of hardware in a built-in system in parallel, high-precision coordination simulation is demanded.

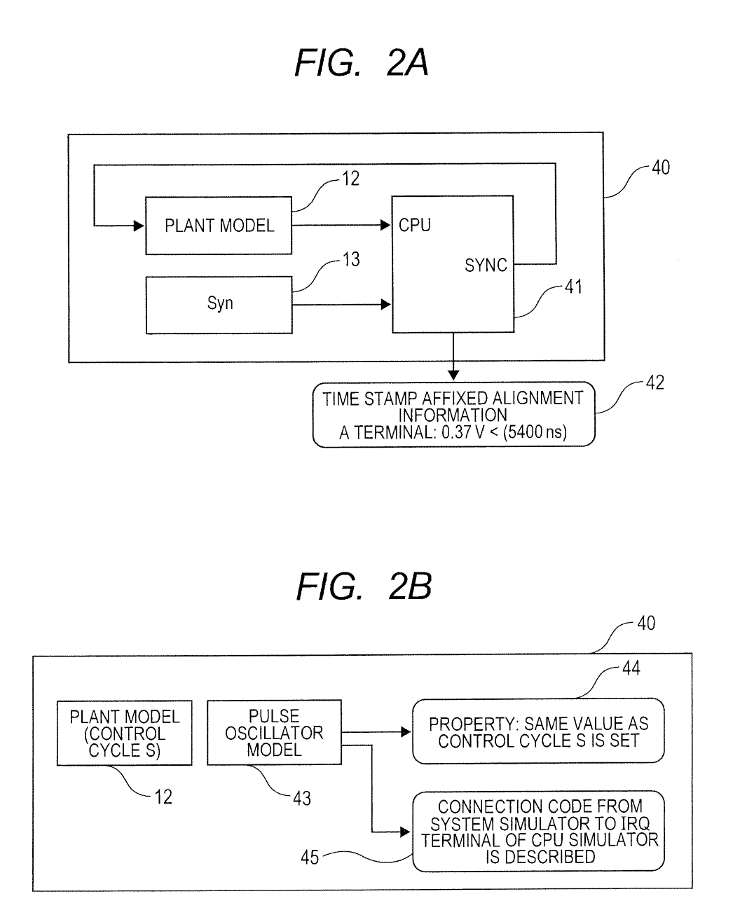

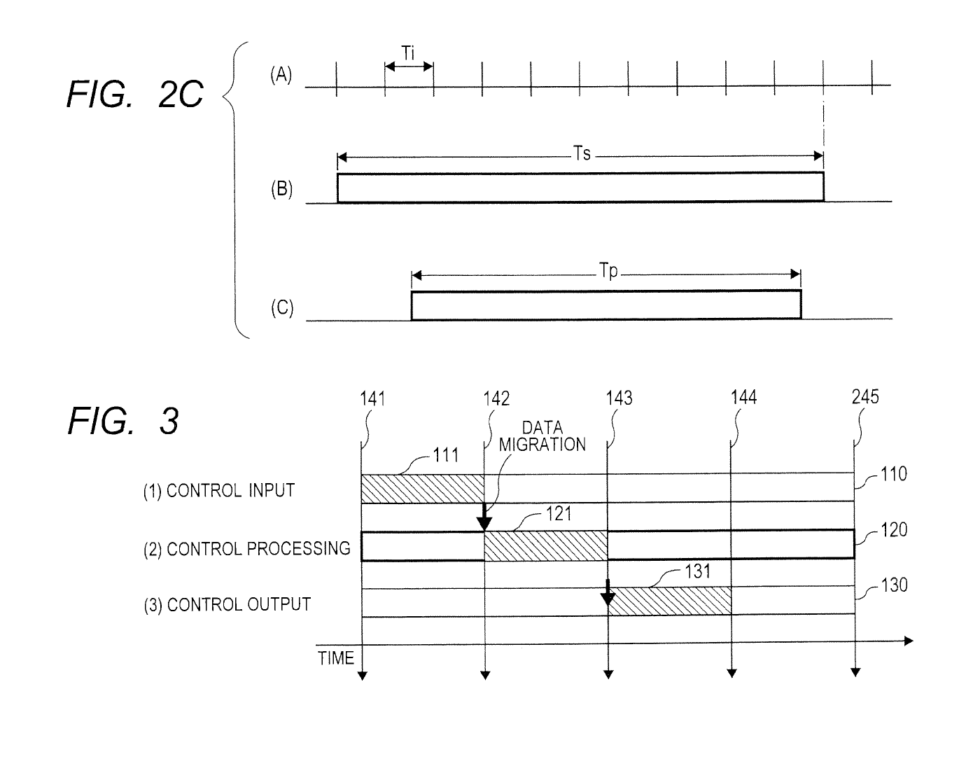

Referring to FIG. 2A, the hardware configuration of the plant model in the coordination simulation system shown in FIG. 1 and its operation will be described below. A hardware configuration of plant model 40 is provided with the plant model 12, the synchronizing pulse oscillator (Syn) 13 and CPU/SYNC 41 as a module. The plant model 12 generates a synchronizing signal that provides system simulator data update timing and others based upon the clock system. The synchronizing pulse oscillator (Syn) 13 generates a pulse signal using the synchronizing signal as it is. The CPU/SYNC 41 outputs the synchronizing signal SYNC generated in the plant model 12 and alignment information (Tcp) to which a time stamp is affixed based upon output (CPU) from the plant model 12 and the output (Syc) of the synchronizing pulse oscillator 13.

The time stamp is the information of a date on which the operation is performed and time which a file system such as OS records as a file attribute. One example of data to which a time stamp is affixed is as follows.

A terminal: 0.37 V (5400 ns)

In this case, “5400 ns” shows time since the start of simulation in the system simulator 10.

Referring to FIG. 2B, the software configuration of the plant model in the coordination simulation system shown in FIG. 1 and its operation will be described below. In the software configuration of plant model 40, the same value as the control cycle S of the system simulator and the microcomputer model is set as the property of a pulse oscillator model 43 by a user. Further, a connection code 45 from the system simulator 10 to the IRQ terminal of the CPU simulator 30 is described by the user.

Hereby, a signal from the Syn 13 is virtually connected to the IRQ (an interrupt acceptance terminal) 33 and is transmitted as a part of data exchanged between the system simulator 10 and the CPU simulator 30.

FIG. 2C shows relation among a communication interval Ti between the two simulators, a sampling/control cycle Ts and CPU processing time Tp in the present invention. Ti, Ts and Tp are required to meet the following expression (1). The communication interval Ti is approximately 1/10 of the control cycle Ts, for example, approximately 2 μs.

((int)(Ts/Ti)−1)*Ti>Tp (1)

FIG. 3 shows a pipeline of processing over the system simulator 10 by the control model as a comparative example. Vertical lines 141 to 245 show the update timing of the control cycle. A reference numeral 110 denotes the data transition of input to control, 111 denotes notable data of control input, 120 denotes the data transition of control processing, 121 denotes notable data of the control processing, 130 denotes the transition of data output from the control model, and 131 denotes notable data of control output. Further, reference numerals 141 to 245 denote system simulator data update timing. In the comparative example shown in FIG. 3, the input 110 to the control model, the processing 120 in the control model and the output 130 from the control model are performed in pipelining in the system simulator 10. In other words, in the system simulator 10, processing without delay is executed in synchronization with the update timing.

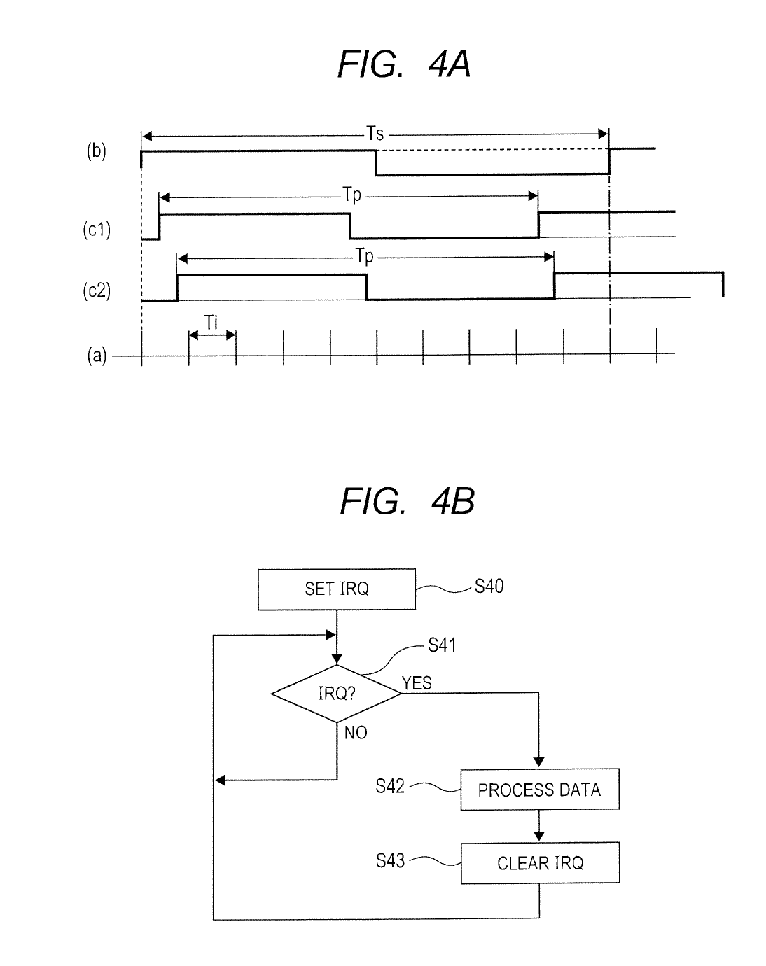

Referring to FIG. 4A, the operation of the microcomputer model 32 of the CPU simulator 30 in the coordination simulation system shown in FIG. 1 will be described below. FIG. 4A shows relation in a phase between the sampling/control cycle Ts and the CPU processing time Tp. As the system simulator 10 and the CPU simulator 30 are provided with each independent clock system, a phase of the CPU processing time Tp and a phase of the sampling/control cycle Ts ordinarily have a time lag. In other words, phases at each leading edge of Ts and Tp are independently controlled and the timing of both is often unmatched.

FIG. 4B is a flowchart for explaining interruption action by the synchronization adapter in the coordination simulation system shown in FIG. 1.

In a state in which the IRQ 33 is set (S40), when IRQ, that is, a leading edge synchronous with system simulator data update timing is detected (S41), an interrupt occurs in the microcomputer model 32, the program is executed, and processing corresponding to data to which a time stamp is affixed is performed (S42). For example, processing that the voltage of an A terminal is turned 0.37 V is performed in the microcomputer model 32 in the time of 5400 ns since of the initiation of simulation. After the processing is finished, the IRQ is cleared (S43) and the next detection of the IRQ is awaited. Hereby, a phase of the CPU processing time Tp is matched with a phase of the sampling/control cycle Ts and processing without delay is performed.

In the present invention, the delay 231 of processing in the conventional type system is inhibited by adopting the synchronization adapter and providing a pulse signal generator that generates a pulse signal synchronized with the update timing of the plant model and configuration that receives the pulse in the microcomputer model, generates an interrupt and synchronizes both simulators. Further, as a pulse signal is generated using a synchronizing signal generated in the plant model as it is, the configuration is simple and the configuration does not hinder the operation of the plant model and the microcomputer model.

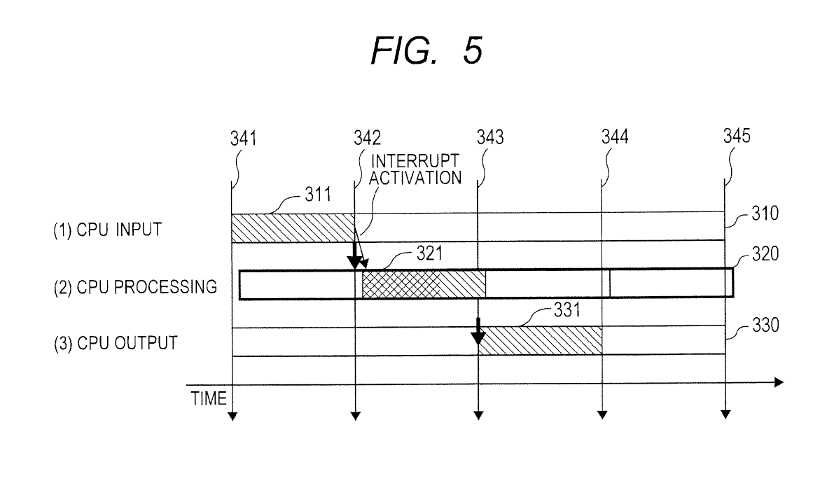

FIG. 5 shows a pipeline of processing when the synchronization adapter is applied in the present invention. In FIG. 5, a reference numeral 310 denotes the temporal string of data (the transition of data input to the CPU) output from the plant model 12 (input to the microcomputer model), 320 denotes the temporal string of processing by the microcomputer model 32 (the transition of data processed by the CPU), and 330 denotes the temporal string of control data from the microcomputer model 32 to the plant model 12 (the transition of data output from the CPU). A reference numeral 311 denotes notable data input to the CPU, 321 denotes notable data processed by the CPU, and 331 denotes notable data output from the CPU. Further, downward arrows 341 to 345 that pierce 310 to 330 show the update timing of the system simulator.

In FIG. 5, the notable data 321 is hatched. An interrupt signal from the Syn 13 is input to the IRQ 33 of the microcomputer model 32 at the system simulator data update timing 342, a control processing program is activated, the notable input to the CPU 311 in the temporal string 320 of control data is read, and processing by the CPU is executed. The substantial processing time of the CPU is shown by the cross oblique lines 321. As the microcomputer model 32 accepts the interrupt at the update timing 342 of the system simulator and the processing is initiated, the processing of the notable data 321 is finished by the next update timing 343 and the output from the CPU 331 is prepared in the temporal string 330 of the control data. Hereby, the process is realized by only the system simulator. Like the timing in the case of the one system simulator 10 shown in FIG. 3, verification without delay can be realized.

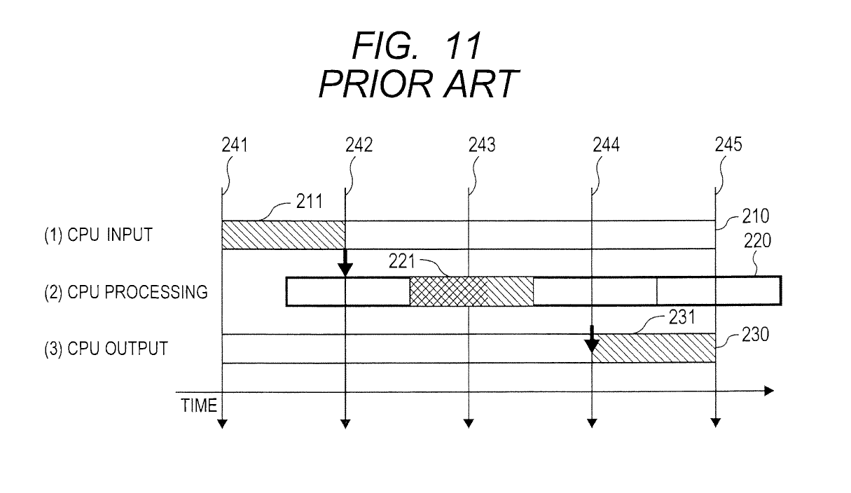

To ordinarily prevent the delay shown in FIG. 11 from being caused, as relation among an interval Ti of the exchange of data to which a time stamp is affixed between both simulators, an interval Ts of the control cycle and processing time Tp in the CPU simulator executed corresponding to the control cycle, it is required that time acquired by multiplying a value acquired by subtracting ‘1’ from a quotient acquired by dividing Ts by Ti by Ti is longer than Tp. That is, it is required to meet relation in the following expression (1).

((int)(Ts/Ti)−1)*Ti>Tp (1)

In the example shown in FIG. 4A, in a case that Ti=1, Ts=10, and Tp=8, the relation of “(10−1)*1>8” is met.

Conversely, as long as the expression (1) is met, a communication interval between the simulators can be lengthened and the running time of the simulator can be reduced.

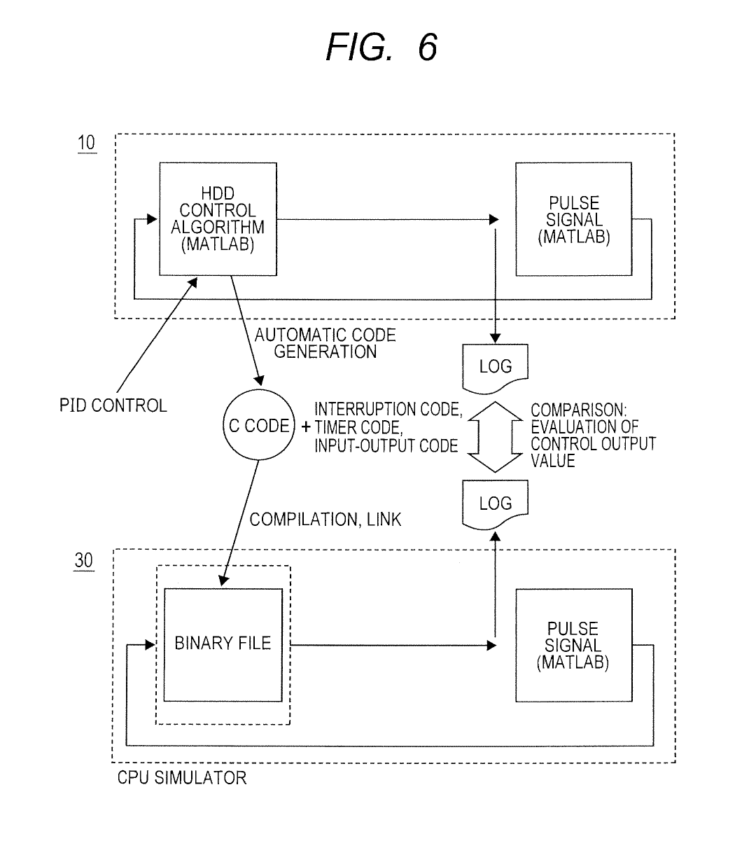

FIG. 6 shows an example that the coordination simulation according to the present invention is applied to a coordination simulation system according to the control algorithm of a hard disk drive (HDD) and analysis by MATLAB and the calibration of coordination simulation are performed. A concrete control object is a head positioning servo control mechanism that performs servo control so that a head of the hard disk drive tracks the same track of a disk. A system simulator 10 is acquired by combining HDD control algorithm that performs PID control as a plant model and MATLAB analysis, and a CPU simulator 30 is acquired by combining a binary file compiled based upon the HDD control algorithm and MATLAB analysis. For calibration, logs of the output of both simulators are compared and a control output value based upon a pulse response is evaluated.

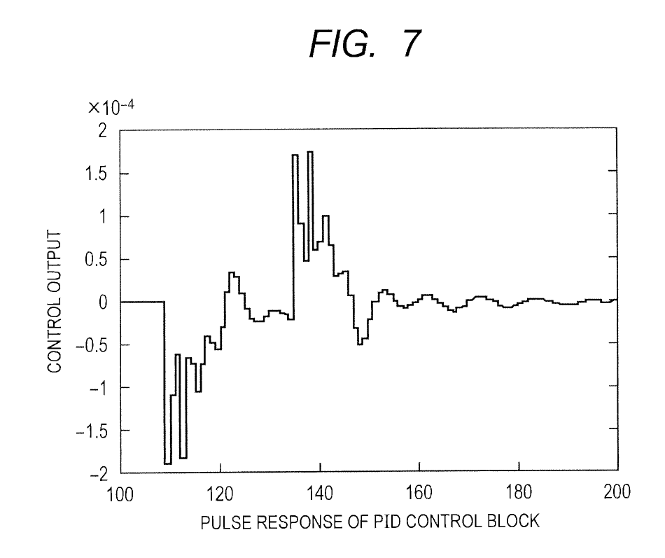

FIG. 7 shows a result of evaluating the effect of the adoption of a synchronization adapter by the method shown in FIG. 6 when the coordination simulation according to the present invention is applied to a coordination simulation system of HDD. In other words, the coordination simulation according to the present invention is evaluated by the method shown in FIG. 6. The axis of ordinates shows control output and the axis of abscissas shows a pulse response of a PID control block. Waveforms of control algorithm (MATLAB) and a microcomputer model (coordination simulation) completely coincide because the synchronization adapter is adopted, and thus the precise coordination simulation can be realized.

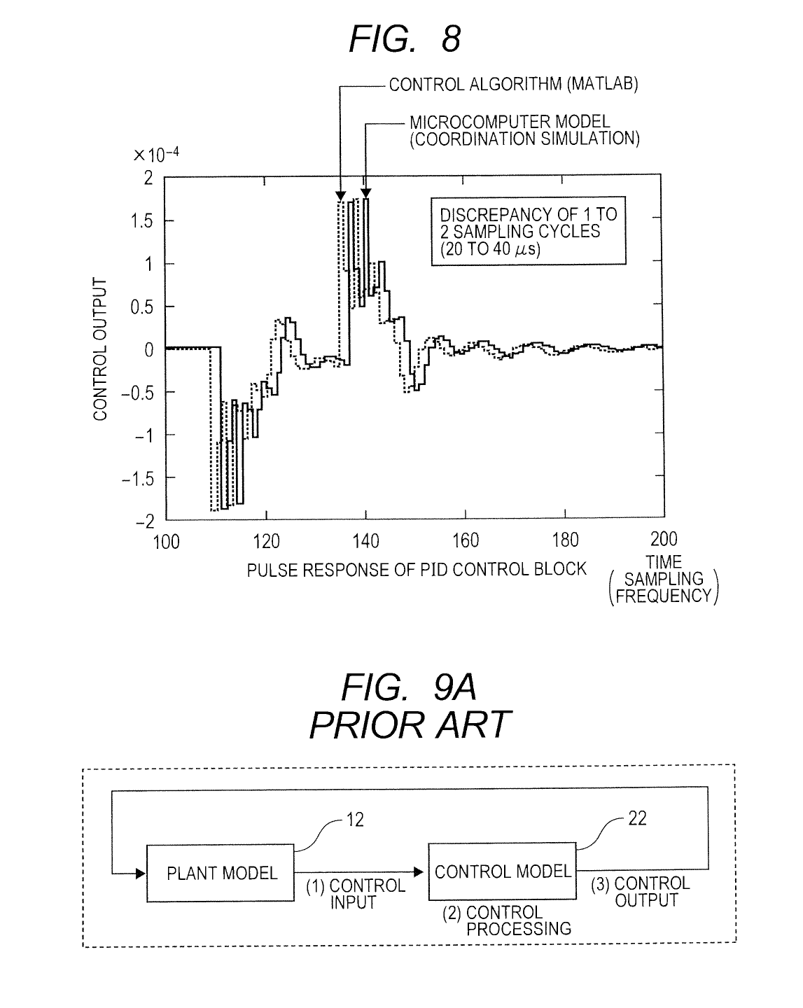

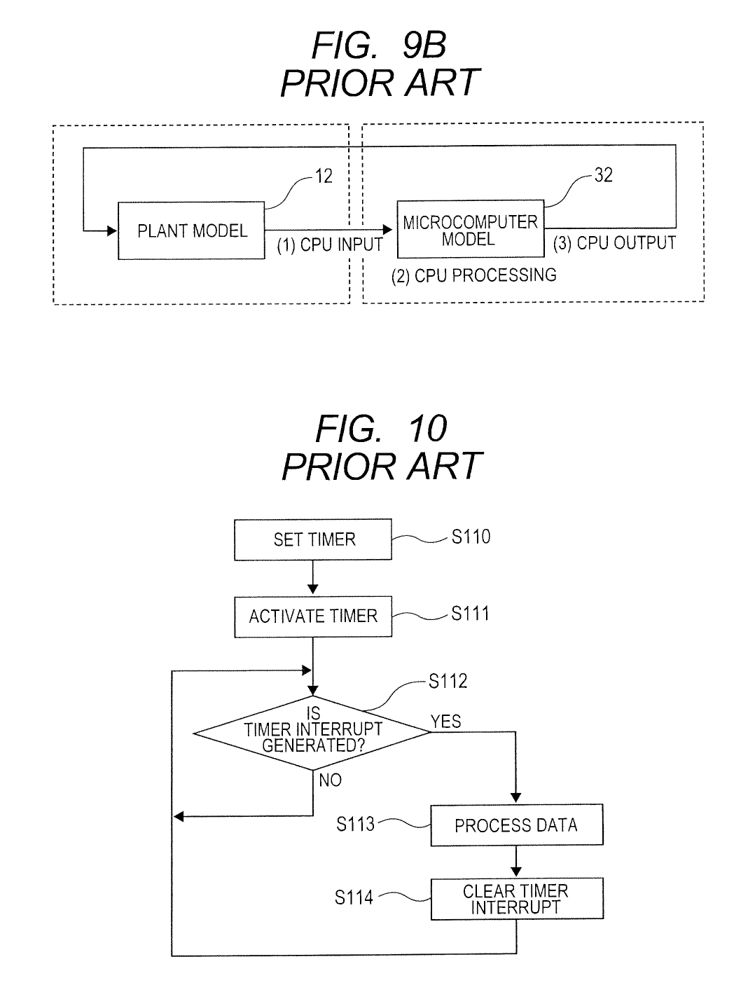

FIG. 8 shows a result of evaluating a case that no synchronization adapter is adopted in the coordination simulation system of the HDD by the method shown in FIG. 6 as a comparative example. In this case, a lag occurs on the side of the coordination simulation for the control algorithm. That is, the lag of 1 to 2 sampling cycles (20 μs to 40 μs) occurs on the side of the coordination simulation and the precision of the coordination simulation is deteriorated.

As described above, according to this embodiment, as input-output to/from the CPU simulator is made in one cycle (one control cycle Ts) of the system simulator simply by adding a function of the synchronization adapter between both simulators, the precise coordination simulation can be ordinarily realized. Further, since the synchronization adapter uses a synchronizing signal from the plant model as it is, the control algorithm of the plant model is not influenced, a method of stepping the system simulator is not required to be changed, and the coordination simulation can be realized with the simple configuration.

### Second Embodiment

In the first embodiment, the example that the control cycle is one is described. However, when a control cycle has plural different values as described above, as many terminals as control cycles are provided to corresponding IRQ 33 and both simulators have only to be virtually connected. For example, there is a case that for a control cycle, plural different cycles such as 20 μs, 10 ms, 1 s and 10 s are used. In this case, as a CPU simulator 30 is a microcomputer model in the simulator, the number of IRQ terminals can be increased by only rewriting a code of the microcomputer model according to the number of control cycles.

Further, in the first embodiment, the control program of the microcomputer model is executed by an interrupt to the IRQ 33. However, a value of a timer may be set to a limit −1 and a control program of the microcomputer model may also be activated by an interruption routine of the timer. In addition, in this case, the microcomputer model may also accept a pulse from Syn 13 per several control cycles.

According to this embodiment, since input-output to/from the CPU simulator is made in synchronization with a control cycle of a system simulator simply by adding a function of a synchronization adapter between both simulators, ordinarily precise coordination simulation can be realized. Further, since the synchronization adapter uses a synchronizing signal from a plant model as it is, control algorithm of the plant model is not influenced, a method of stepping the system simulator is not required to be changed, and coordination simulation can be realized with the simple configuration.

What is claimed is:

1. A coordination simulation system in which a system simulator of a plant model and a CPU simulator that controls by a microcomputer model are configured via a feedback loop, comprising:
a synchronization adapter that synchronizes the system simulator and the CPU simulator,
wherein the synchronization adapter includes a function that provides alignment information per control cycle to the microcomputer model in accordance with a synchronizing signal from the plant model.

2. The coordination simulation system according to claim 1,
wherein the synchronization adapter exchanges data to which a time stamp is affixed with the both simulators at a fixed interval, and
the synchronization adapter is provided with a function that generates an interrupt to a CPU of the CPU simulator at the data update timing of the system simulator.

3. The coordination simulation system according to claim 2,
wherein the synchronization adapter includes:
a synchronizing pulse oscillator that generates a pulse signal in the system simulator using a synchronizing signal from the plant model as it is; and
an interruption request terminal provided to the CPU simulator,
wherein a signal from the synchronizing pulse oscillator is set to the data to which the time stamp is affixed.

4. The coordination simulation system according to claim 1,
wherein, in relation among an interval Ti of the exchange of data to which a time stamp is affixed between the both simulators, an interval Ts of the control cycle of microcomputer model and a time Tp of processing executed corresponding to the control cycle by the CPU simulator, time acquired by multiplying a value acquired by subtracting ‘1’ from a quotient acquired by dividing the Ts by the Ti by the Ti is longer than the Tp.

5. The coordination simulation system according to claim 3,
wherein an interrupt is made to the microcomputer model in synchronization with the data update timing of the system simulator so as to make a phase of processing time by the CPU simulator and a phase of the control cycle coincide.

6. The coordination simulation system according to claim 3,
wherein when a plurality of the control cycles are provided, as many of the interruption request terminals as these control cycles are provided to the CPU simulator so as to virtually connect the both simulators.

7. The coordination simulation system according to claim 1,
wherein the synchronization adapter exchanges data to which a time stamp is affixed between the both simulators every fixed interval; and
a control program of the microcomputer model is activated according to an interruption routine of a timer synchronized with the control cycle.

8. A coordination simulation method of operating a plurality of simulators in a linked state,
wherein the plurality of simulators configure a coordination simulation system in which a system simulator including a plant model and a CPU simulator that controls by a microcomputer model are configured via a feedback loop; and
the coordination simulation system includes a synchronization adapter that synchronizes the system simulator and the CPU simulator,
wherein the method comprising the steps of:
providing alignment information per control cycle to the CPU simulator at the data update timing of the system simulator; and
generating an interrupt to the microcomputer model based upon the alignment information and executing a program in the microcomputer model.

9. The coordination simulation method according to claim 8, wherein the method further comprising the steps of:
exchanging data to which a time stamp is affixed between the both simulators at a fixed interval; and
generating an interrupt to a CPU of the CPU simulator at the data update timing of the system simulator.

10. The coordination simulation method according to claim 8, wherein the method further comprising the steps of:
exchanging data to which a time stamp is affixed between the both simulators at a fixed interval; and
activating a control program of the microcomputer model according to an interruption routine of a timer synchronized with the control cycle.
